(19) United States
(12) Patent Application Publication
(10) Pub. No.: US 2011/0169987 A1
(43) Pub. Date: Jul. 14, 2011

(54) Minimally Processing Displayed Images Captured From A Burst

(76) Inventor: Robert G. Gann, Bellvue, CO (US)

(21) Appl. No.: 13/062,428

(22) PCT Filed: Sep. 15, 2008
(86) PCT No.: PCT/US2008/076338

§ 371 Date: Mar. 4, 2011

(51) Int. Cl. H04N 9/64; H04N 5/228

(52) U.S. Cl. 348/246; 348/222.1; 348/E09.042

(57) ABSTRACT

One embodiment minimally process a burst of images captured with an image capture device. The images are displayed, and maximum processing is performed on one of the images.

### FIELD OF THE INVENTION

The present invention relates to image capturing devices and more particularly to minimally processing displayed images captured from a burst.

### BACKGROUND

After a digital camera captures an image, a significant amount of image processing is performed on raw image data to render the captured image to a display. The raw image data is often processed, stored in a frame buffer, compressed with a compression algorithm, and then stored in nonvolatile memory. Once an image is fully rendered, it is displayed to a user on a display of the camera.

Final rendering of a digital image can require several seconds of processing. This is particularly true of more advanced processes used to render good images out of limited quality data, such as the images captured by low cost camera phones. For example, noise filters on a camera phone can process a large megapixel image for several seconds before displaying the rendered image to a user. If a sequence of images is captured in rapid succession, then this processing time can be considerable and result in extreme delays in displaying pictures to users.

### BRIEF DESCRIPTION OF THE DRAWINGS

FIG. 1 illustrates a schematic view of an image capturing device in accordance with an exemplary embodiment of the present invention.

FIG. 2 illustrates a flow chart for minimally processing displayed images captured from a burst in accordance with an exemplary embodiment of the present invention.

FIG. 3 illustrates a flow diagram for minimally processing displayed images captured from a burst in accordance with an exemplary embodiment of the present invention.

### DETAILED DESCRIPTION

Exemplary embodiments relate to methods and apparatus for minimally processing displayed images captured from a burst in an image capturing device. After images are captured during a burst, the images are minimally processed and displayed to a user. The user or image capturing device then selects one or more of the best displayed images, and these selected images are subject to more advanced processing to render final and high quality images.

One exemplary embodiment is a handheld digital camera, such as a camera phone, that enables a user to quickly capture a series or burst of images. The user can then review the captured images and select one or more of the best or favorite images. Selected images are subsequently fully processed, while non-selected images are discarded or not subject to full image processing. Hence, significant time and processing power are saved since the camera only fully processes the images selected by the user or image capture device. Furthermore, since images are initially and quickly pre-processed before being subject to full processing, the images are immediately available for review on a display. A user is not required to wait for multiple images captured during a burst to be fully processed before being viewed on the display of the camera.

One exemplary embodiment uses multi-tiered processing to immediately display a sequence of images captured during a burst. One embodiment utilizes limited, but high speed, image processing to initially create photos that are good enough to display on a handheld portable image capture device, but not good enough for final uses that require higher image quality. Because of the speed of capture, a burst of images can be quickly and immediately displayed to a user.

In one exemplary embodiment, image processing occurs in two separate stages at two separate times. During a first minimal processing stage, images captured during a burst are processed just enough to display the images to a display on the image capture device. The minimal processing stage generates a relatively low quality image that is sufficient for display on a small handheld portable image capture device. The user can immediately view the images and select one or more of the images. Alternatively, the image capture device can automatically select one or more of the best captured images. Selected images are then processes again during a second full processing stage or maximum processing stage. During this second stage, the selected image or images are subject to more intensive processing to yield higher quality images. More advanced processing occurs during the second stage to produce a final quality rendered image.

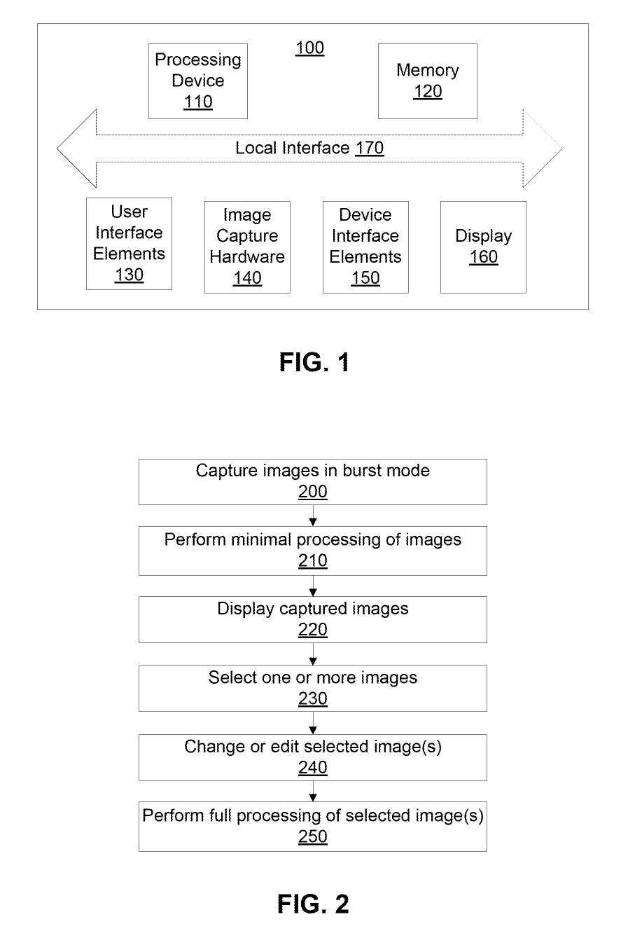

FIG. 1 illustrates a schematic view of an image capturing or capture device 100 in accordance with an exemplary embodiment of the present invention.

The image capturing device 100 comprises a processing device 110, memory 120, user interface elements 130, image capture hardware 140, device interface elements 150, a display 160, and a bus or local interface 170 to which each of the other components electrically connects. The processing device 110 executes commands stored in memory 120 and comprises a general-purpose processor, a microprocessor, one or more application-specific integrated circuits (ASICs), a plurality of suitably configured digital logic gates, and/or other electrical configurations to coordinate and process the overall operation of the image capturing device 100.

The user interface elements 130 comprise interface tools with which the device settings are changed and through which the user communicates commands to the image capturing device 100. By way of example, the interface elements 130 comprise one or more functional buttons or modes with which the image capturing device 100 is controlled or commanded to capture images. Further, the user interface elements 130 include, but are not limited to, an optional user input device (example, a keyboard or a mouse) and an optional input/output (I/O) device used to couple the image capturing device 100 to a network.

The image capture hardware 140 comprises various components used to physically capture images. In one exemplary embodiment, the image capture device 100 is a handheld portable or non-portable digital camera (still and/or video) in which the image capture hardware 140 includes, for example, a lens, one or more focusing elements (lenses, mirrors, etc.), one or more light sensing elements (for example, a charge-coupled device (CCD)), or viewfinder, to name a few examples.

The device interface elements 150 facilitate the transfer of image data from the image capturing device 100 to other devices, such as computing devices and peripheral devices (for example, printers). By way of example, these interface elements comprise a data transmitting/receiving device and one or more communication ports. In one exemplary embodiment, communications or data transmission is wireless or conducted through direct electrical connection.

In one embodiment, the image capturing device 100 comprises a user output device, such as a display 160. The display is coupled to the local interface or bus 170 for displaying information, such as stored or captured images to the user. In one exemplary embodiment, the display 160 is a liquid crystal display (LCD) that displays information, such as images captured by the image capturing device 100, alphanumerical characters, graphics, etc.

The memory 120 includes various components such as an operating system, an image capture module, a communication module, a focus quality analysis and selection module, etc. The operating system contains various commands used to control the general operation of the image capturing device 100 and comprises software and/or firmware that facilitate the capture (i.e., retrieval and storage) of images in conjunction with the image capture hardware 140. Accordingly, captured image data is displayed, outputted, or otherwise manipulated by these other devices.

In one exemplary embodiment, the image capturing device 100 is an electronic device, such as, but not limited to, a digital camera (still and/or video), personal digital assistant (PDA), cellular or mobile telephone, a web camera, a computing device, digital imaging devices, or other portable or non-portable electronic computing devices. Further, the image capturing device 100 is not limited to an apparatus but includes computer and electronic systems. In one exemplary embodiment, the image capturing device 100 connects to a separate computing device (example, a personal computer or server) and/or connects to a network, such as the internet.

FIG. 2 illustrates a flow chart for minimally processing displayed images captured from a burst in accordance with an exemplary embodiment of the present invention.

According to block 200, the image capture device captures a series of images in rapid succession, such as in a burst mode. In one exemplary embodiment, the image capture device rapidly captures a sequence of images or bursts of images in rapid succession.

According to block 210, the image capture device performs minimal processing on the captured images. After the images are minimally processed, the images are stored either in an internal buffer memory or on an external memory card. The initial processing of the images (i.e., minimally processing of images) is just good enough to create low quality images that appear good or acceptable on a display of the image capture device. The initial or minimal processing ignores items such as noise, advanced defective pixel correction, etc. that address image artifacts that are not visible on the display. Minimal processing can include such functions as quick de-mosaic and other processing of raw image data to scale down pixels and resolution.

According to block 220, the captured images are displayed to the user. For example, the captured images are displayed on the display of the image capture device.

According to block 230, the user or image capture device selects one or more of the captured images. For example, the user reviews the captured images on the display and selects one or more of the images. By way of illustration, the user or image capture device selects one or more of the best or favorite images captured during the burst.

According to block 240, the user or image capture device can make edits, alterations, or corrections to the one or more selected images. For example, the corrections include, but are not limited to, one or more of red eye removal, teeth whitening, or color corrections. The user can make similar changes to all of the images perform different changes/edits to different selected images.

According to block 250, the image capture device performs full processing on the selected image or images and avoids full or maximum processing of other non-selected images. As such, only a selected image or images (i.e., a subset of the burst of images captured) are maximally processed to save time and processing power.

After the initial minimal processing, the image capture device performs post processing on the minimally rendered images to create fully rendered, high quality images that can be printed or displayed on larger or higher resolution displays. By postponing the final rendering, exemplary embodiments enable rapid capture and immediate display of a burst of images with limited processing power. Later, the selected images are fully rendered when the time required to do so is available (for example, when the processor of the image capture device is idle or the user is not capturing images).

In one exemplary embodiment, full processing includes one or more of de-mosaic, noise filtering, image sharpening, extended dynamic range processing, red eye removal, advanced white balancing, color adjustment, tone mapping or tonal reproduction, cropping, etc. One or more of these tasks are not performed during the minimal processing stage to save time and processing power (i.e., processing power is saved since unwanted images captured during the burst are not maximally processed).

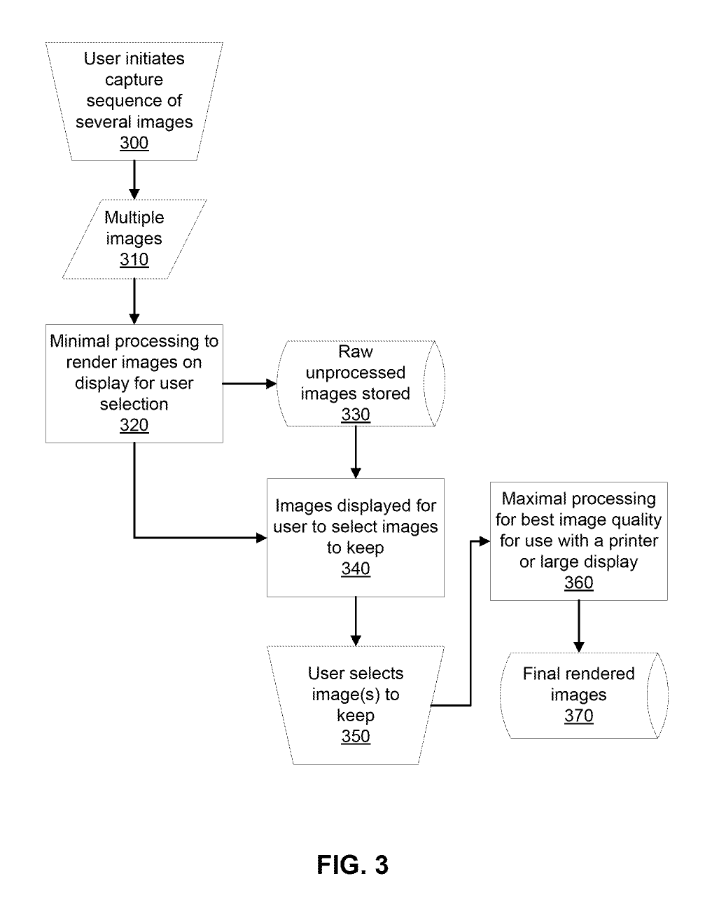

FIG. 3 illustrates a flow diagram for minimally processing displayed images captured from a burst in accordance with an exemplary embodiment of the present invention.

As shown in block 300, the user initiates capturing of a sequence of multiple images 310. Minimally processing is performed to render images on the display for the user to make a selection of a best or favorite image in the sequence as shown in block 320. After the minimal processing, the multiple images are stored as raw unprocessed images in memory, as shown in a storage container 330. Images are presented on the display according to block 340, and a user makes one or more selections of images according to 350. Next, maximal processing is performed for best image quality for transmission to or use with a printer or large display shown in 360. The final rendered images can be output to a peripheral device, stored in the image capture device, stored in an external location, transmitted from the image capture device, etc. as shown at 370.

One exemplary embodiment is a camera phone that includes an image processor that has a fast, but limited hardware based image processing pipeline and also a DSP (digital signal processor) or general purpose computing processor that allows higher quality processing when time is available. Typically, s/w or f/w based image processing is better able to mitigate problems in the image, particularly problems that are specifically tied to a particularly sensor or lens sensor array than a fixed hardware based I-pipe. As an image is captured, the image is rendered enough to be acceptable on the display on the camera or camera phone, but the final high quality rendering is deferred to a time when the user is not trying to capture images.

Exemplary embodiments provide benefits in both burst/best shot modes and enable fast and effective shot-to-shot performance without limiting final image quality. Furthermore, exemplary embodiments utilize lower processing power systems to achieve burst/rendering speeds equivalent to high processing power systems. For example, exemplary embodiments recognize limitations of the display on small image capture devices (for example, a portable camera or camera phone) and use these limitations to allow lower quality initial rendering. The final, full quality rendering is deferred and only applied to images that are selected by the user for saving. As such, image capture devices in accordance with exemplary embodiments are more responsive to user inputs (taking pictures), but still deliver images that are rendered to the best quality possible by deferring processing until the image capture device is idle.

### DEFINITIONS

As used herein and in the claims, the following words are defined as follows:

The word “burst” means a series or sequence of rapidly captured images. For example, a sequence of three or more pictures is captured upon actuation of a single mechanism (for example, a mechanical or electronic button) on an image capturing device.

The terms “full processing” or “maximum processing” or “maximally processing” mean processing images enough to render them to a high quality display (such as a computer display) or high quality reproduction (such as a printer).

The terms “minimal processing” or “minimally processing” mean processing images enough to render them to a camera display or local display as opposed to a high quality display (such as a computer display) or high quality reproduction (such as a printer).

The methods in accordance with exemplary embodiments of the present invention are provided as examples and should not be construed to limit other embodiments within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method, comprising:
capturing a sequence of digital pictures in rapid succession with an image capture device;
performing minimal processing to render the pictures to a display of the image capture device;
receiving a user selection of one of the pictures; and
performing maximum processing with the image capture device on the one of the pictures.

2) The method of claim 1 further comprising, outputting the one of the pictures for use with a high quality photographic reproduction device.

3) The method of claim 1 further comprising, saving processing power by performing the maximum processing only on the one of the pictures.

4) The method of claim 1 further comprising, receiving user edits to the one of the pictures before performing the maximum processing.

5) The method of claim 1 further comprising, deferring the maximum processing of the one of the pictures until the image capture device is idle.

6) An image capture device, comprising:
a display; and
a processor that captures a burst of images, minimally processes the burst of images, displays the burst of images on the display, selects one image of the burst of images, maximally processes only the one image, and avoids maximally processing of other images in the burst of images.

7) The image capture device of claim 6, wherein the image capture device is a mobile telephone.

8) The image capture device of claim 6, wherein the one of the images represents a best image captured in the burst of images.

9) The image capture device of claim 6, wherein minimally processing generates low resolution images and maximally processing generates high resolution images.

10) The image capture device of claim 6, wherein minimally processing is less process intensive than maximally processing so that the burst of images can be immediately displayed on the display after the burst of images is captured.

11) A tangible computer readable storage medium having instructions for causing a computer to execute a method, comprising:
receiving a burst of images captured with an image capture device;
performing minimal processing to display the images with a low resolution on the image capture device; and
performing maximum processing with the image capture device on one of the images to generate a high resolution image.

12) The tangible computer readable storage medium of claim 11 further comprising, ignoring noise and defective pixel correction that result in changes not visible on a display of the image capture device.

13) The tangible computer readable storage medium of claim 11 further comprising, displaying the burst of images on a display of the image capture device so a user can select a favorite one of the burst of images before the maximum processing occurs.

14) The tangible computer readable storage medium of claim 11 further comprising, postponing final rendering of the burst of images to enable rapid capture and display of the burst of images with limited processing power.

15) The tangible computer readable storage medium of claim 11 further comprising, performing the maximum processing only on the one of the images and not other images in the burst of images.
